(19) United States
(12) Patent Application Publication
(10) Pub. No.: US 2021/0293625 A1
(43) Pub. Date: Sep. 23, 2021

(54) Multi-spectral temperature measuring device based on adaptive emissivity model and temperature measuring method thereof

(71) Applicant: Harbin Engineering University, Harbin (CN)

(72) Inventors: Shan Gao, Harbin (CN); Tong Wang, Harbin (CN); Liwei Chen, Harbin (CN); Ying Cui, Harbin (CN); Chunhui Zhao, Harbin (CN); Chao Wang, Chengdu, (CN); Jing Jiang, Chengdu (CN)

(73) Assignee: Harbin Engineering University

(21) Appl. No.: 17/227,363

(22) Filed: Apr. 11, 2021

(30) Foreign Application Priority Data
Aug. 31, 2020 (CN) 202010895227.2

(51) Int. Cl. G01J 5/00; G01K 7/02; G01J 5/08; G06N 3/08

(52) U.S. Cl. CPC G01J 5/0003; G01K 7/02; G01J 2005/0074; G06N 3/084; G01J 5/0887

(57) ABSTRACT

A multi-spectral temperature measuring device based on adaptive emissivity model and temperature measuring method thereof are provided, which is configured to measure the temperature of the surface of an object under a high temperature background. The present invention relates to the technical field of radiation temperature measurement. The present invention provides a multi-spectral temperature measurement device based on an adaptive emissivity model, includes a pyrometer, a radiation detector, a constant temperature furnace, a cooling cavity, a cold air inlet pipe, a cold air outlet tube, and a thermocouple and thermocouple acquisition card. In order to more accurately measure the surface temperature of the object in a high-temperature environment, a BP network is provided to adaptively find the emissivity model, and through pre-training the network, the network has a high degree of recognition, and then classifies the spectral curve to accurately output the corresponding emissivity model.

### CROSS REFERENCE OF RELATED APPLICATION

The present application claims priority under 35 U.S.C. 119(a-d) to CN 202010895227.2, filed Aug. 31, 2020.

### BACKGROUND OF THE PRESENT INVENTION

### Field of Invention

The invention relates to the technical field of radiation temperature measurement, and more particularly to a multi-spectral temperature measurement device based on an adaptive emissivity model and a temperature measurement method thereof.

### Description of Related Arts

Multi-spectral temperature measurement is a temperature measurement method that indirectly obtains the true temperature by measuring the spectral radiance of an object under multiple wavelength conditions. It does not require auxiliary equipment and additional information, and has no special requirements for the object to be measured, so it is especially suitable for measuring the true temperature of high-temperature targets. However, there are several difficulties in measuring target temperature under high temperature background as follows.

1. The pyrometer will receive radiation from the target surface and the high-temperature environment at the same time during temperature measurement. If the influence of the high-temperature background is ignored, the multi-spectral temperature measurement method is used to solve the problem. The calculated temperature value will have a large error.

2. Since the true temperature of the surface of the object is unknown, the use of multi-spectral temperature measurement to measure the temperature will result in over-determined equations with the number of unknowns greater than the number of equations, which cannot be solved directly. A commonly used method is to assume the emissivity change law with wavelength in advance and substitute it into the over-determined equations to solve it. However, if the hypothetical model differs greatly from the actual situation, a large error will occur.

3. Even if the emissivity model is determined, it is more difficult to directly solve the equation set consisting of the radiation relationship of each channel of the pyrometer, and it needs to be transformed into a constrained optimization problem. In order to solve such problems, a high precision and short time-consuming calculation algorithm is required.

### SUMMARY OF THE PRESENT INVENTION

In order to more accurately measure the temperature of the surface of an object in a high-temperature environment, the present invention provides a multi-spectral temperature measurement device and a temperature measurement method based on an adaptive emissivity model. The present invention provides the following technical solutions:

A multi-spectral temperature measuring device based on an adaptive emissivity model, comprises: a pyrometer, a radiation detector, a constant temperature furnace, a cooling chamber, a cold air inlet pipe, a cold air outlet pipe, a thermocouple and a thermocouple collection card;

wherein the pyrometer is connected to a radiation detector, and the constant-temperature furnace has a small hole larger than the radiation detector. The radiation detector measures the optical radiation data of the sample to be tested through the small hole. The sample to be tested is placed in the cooling chamber, so A cold air inlet pipe and a cold air outlet pipe are arranged in the cooling cavity, the sample to be tested is connected to a thermocouple, and the thermocouple is connected to a thermocouple acquisition card.

Preferably, the thermocouple adopts a K-type thermocouple, and the thermocouple acquisition card adopts a 16-channel thermocouple acquisition card.

A multi-spectral temperature measurement method based on an adaptive emissivity model, comprises the following steps of:

step 1: collecting the spectral radiation data of the sample to be tested within a certain wavelength range through a pyrometer;

step 2: training the BP network and select the emissivity model based on the spectral radiation data of the sample to be tested;

step 3: inputting the spectral radiation data of the sample to be tested into the trained BP network, and select the emissivity model;

step 4: according to the selected emissivity model, transforming the emissivity model into a single objective constrained optimization equation to obtain the objective equation; and

step 5: according to the target equation, the temperature of the sample to be tested is solved.

Preferably, the step 1 specifically comprises:

collecting the spectral radiation data of the sample to be tested in the wavelength range of 1.7-2.2 microns by a pyrometer; wherein the collection process is divided into a stable phase, two cooling processes and two heating processes; first, the temperature of the temperature control room is adjusted to 690° C. to maintain, it takes about 30 s to reach the stable stage; then the cold air is introduced from the cold air inlet pipe to the cooling chamber to reduce the surface temperature of the sample to be tested.

after maintaining it for about 150 s, the cold air is stopped to reach the first cooling stage; after that, the temperature of the sample gradually recovered; after the recovery process lasted 489 s, the temperature of the sample recovered to 681.5° C., reaching the first heating stage; pass the cold air into the cooling chamber again from the cold air inlet pipe to reduce the surface temperature of the sample to be tested; after maintaining for about 150 seconds, stop passing the cold air to the second cooling stage; the temperature of the sample gradually recovered; after the recovery process lasted 489 s, the temperature of the sample recovered to 681.5° C., reaching the second heating stage, completing the collection of the spectral radiation data of the sample to be tested.

Preferably, the step 2 specifically comprises:

step 2.1: according to the four emissivity models, within the range of 1.7-2.2 microns, take one point every 0.1 microns, a total of 6 wavelength points, select the emissivity range of 0.3-1, within the emissivity range and six wavelengths under the conditions of, seven different emissivity data are generated, each with 74 groups, a total of 518 emissivity samples, and in each emissivity sample, 70 groups are taken as the training set emissivity source data, and the remaining 4 sets of emissivity source data as test set;

step 2.2: taking seven 0-1 combinations as classification labels, 1-0-0-0-0-0-0 as the first emissivity label, and 0-1-0-0-0-0-0 as the second One emissivity tag, 0-0-1-0-0-0-0 as the third emissivity tag, 0-0-0-1-0-0-0 as the fourth emissivity tag, 0-0-0-0-1-0-0 as the fifth emissivity label, 0-0-0-0-0-1-0 as the sixth emissivity label, 0-0-0-0-0-0-1 as the seventh emissivity tag;

step 2.3: setting the temperature conditions. Set the ambient temperature to 690° C. Take one point every 10° C. within the range of 575-685° C. for the blackbody temperature. There are 12 temperature points in total. The generated 518 sets of emissivity samples are used in 12 spectral radiation data is generated under temperature conditions, a total of 6216 sets of samples, of which, the spectral radiation data generated from the training set emissivity source data is used as the training sample, a total of 5880 sets, accounting for 94.6% of the total sample, the test set emissivity the spectrum data generated by the source data is used as the test sample, a total of 336 groups, accounting for 5.4% of the total sample;

step 2.4: using a typical three-layer BP network structure, the number of hidden layers is 1 layer, where the number of neurons in the input layer corresponds to the number of wavelengths, which is 6, the number of neurons in the hidden layer is 20, and the number of neurons in the output layer Neurons are used to display the classification results. According to the seven 0-1 combinations, the number of neurons should be set to 7, and the final network structure should be 6-20-7. For the results of the BP neural network, it should be converted to seven according to 0-1 combination, and set the maximum value of the seven neurons to 1, and set the rest to zero to correspond to the classification label;

step 2.5: initializing the network parameters, normalize the spectrum data and transmit it to the BP network. According to the rules of the gradient descent method, the input data is propagated forward and the error is propagated back. The network parameters are constantly updated, and two abort rules are set for iteration, completing BP network training; the two termination rules are specifically;

wherein one of the rules is: the maximum number of iterations is set to 10000; the other is: when the data has not changed for 40 consecutive times, it is not necessary to wait until the maximum number of iterations, and directly terminate.

Preferably, the four emissivity models include an exponential model, a sine model, a linear model and a quadratic model.

Preferably, the type of spectral data is one-to-one corresponding to the type of emissivity shape, and the following formulas are used for different blackbody temperatures and Generate spectral data at ambient temperature:

M_{λ,T}_{ₘ}=ε_{λ}M_{λ,T}_{_{b}}+(1−ε_{λ})M_{λ,T}_{ᵣ};

wherein M_{λ,T}_{ₘ} is the total radiation output received by the detector, M_{λ,T}_{_{b}} is the blackbody radiation output of the measurement target, M_{λ,T}_{ᵣ} is the amount of radiation reaching the surface of the object under test in the surrounding high temperature environment, ε_{λ} is the emissivity of the surface of the object under test, T_{b} is the surface of the object under test on the blackbody temperature is the measurement temperature of the radiation pyrometer, and is the ambient temperature; The difference between the generated spectral shapes is used as the basis for neural network recognition.

Preferably the step 3 is specifically:

selecting six wavelengths, respectively 1.7, 1.8, 1.9, 2.0, 2.1, 2.2 microns, and input the acquired spectrum data into the trained BP network according to the same normalization method as the training data. The judgment rule of the network output result according to the principle of taking the maximum value as 1 and the remaining values as 0, each corresponds to seven classification labels to indicate the classification of spectral data by the network;

selecting the emissivity model with the highest recognition rate of the number of temperature points as the emissivity model; after the recognition of the BP network, the sine model has the highest recognition rate, and the sine model is selected.

Preferably, the step 4 specifically comprises:

according to the selected emissivity model, transforming the emissivity model into a single-objective constraint optimization equation. For a multi-wavelength pyrometer with n channels, after selecting the emissivity model, a set of emissivity values equal to the number of channels is obtained, determining the implicit function equation group between the emissivity coefficient and the target true temperature, and express the implicit function equation group between the emissivity coefficient and the target true temperature by the following formula:

$$\{ \begin{matrix}{M}_{{λ}_{1} , {T}_{b}} = \frac{{M}_{{λ}_{1} , {T}_{m}} - ( 1 - {ɛ}_{1} ) {M}_{{λ}_{1} , {T}_{r}}}{{ɛ}_{1}} \\ {M}_{{λ}_{2} , {T}_{b}} = \frac{{M}_{{λ}_{2} , {T}_{m}} - ( 1 - {ɛ}_{2} ) {M}_{{λ}_{2} , {T}_{r}}}{{ɛ}_{2}} \\ … \\ {M}_{{λ}_{n} , {T}_{b}} = \frac{{M}_{{λ}_{n} , {T}_{m}} - ( 1 - {ɛ}_{n} ) {M}_{{λ}_{n} , {T}_{r}}}{{ɛ}_{n}}\end{matrix}$$

wherein λₙ is the wavelength of an nth channel, εₙ is the emissivity of an nth channel at a wavelength λₙ, M_{λ}_{ₙ}_{,T}_{_{b}} is a wavelength λₙ, and the blackbody temperature T_{b} is the ideal blackbody radiation emission degree, M_{λ}_{ₙ}_{,T}_{ᵣ} is the wavelength λₙ, and the ambient temperature Tᵣ is the ambient radiation under the condition, M_{λ}_{ₙ}_{,T}_{ₘ} is the degree of emission of radiation received by the pyrometer;

converting the implicit function equations between the emissivity coefficient and the target true temperature into an optimized equation for solving the emissivity and the true temperature, and get the target equation through the following formula Δ:

$$\{ \begin{matrix}Δ = min {\sum }_{i = 1}^{n} [ {M}_{{λ}_{i} , {T}_{m}} - ( 1 - {ɛ}_{{λ}_{i}} ) {M}_{{λ}_{i} , {T}_{r}} - {ɛ}_{{λ}_{i}} {M}_{{λ}_{i} , T} ] \\ {ɛ}_{{λ}_{i}} = f ( λ , T ) \\ 0 \leq {ɛ}_{{λ}_{i}} \leq 1\end{matrix}$$

wherein, ε_{λ}_{ᵢ} is the emissivity calculated by the emissivity model at the i-th channel wavelength, with a value ranging from 0 to 1, and T is the true surface temperature of the object to be measured.

Preferably the step 5 specifically comprises:

step 5.1: initializing the population parameters, and set the feasible range of the emissivity model parameters according to the selected emissivity model, the number of population individuals npop, the crossover rate pc, the mutation rate pm, the number of clusters k, the proportion of individuals for symmetric solution px, and the parameters of the maximum number of iterations D;

step 5.2: generating an initial population within the range of feasible solution parameters of the emissivity model, and perform a non-dominated sorting on all individuals in the order of fitness from good to poor according to the target equation;

step 5.3: dividing the population into k clusters according to the Euclidean distance between individuals according to the K-means algorithm, randomly select two clusters, first randomly selecting two individuals in each cluster to perform the binary tournament algorithm, and then performing the crossover operation for pc·npop times, the new individuals pop1 is generated by the cross to form a population;

step 5.4: determining the rules of mutation, randomly selecting pm·npop individuals to perform mutation operations, and the new individuals generated by mutation form a pop2 population, wherein the mutation rules are expressed by the following formula X^{R+1}:

X^{R+1}=X^{R}+F·(X_{Best}^{R}−Xᵢ^{R})

wherein R represents the Rth generation, X represents an individual in the population, Xᵢ^{R} represents any random individual in the Rth generation that is different from X, X_{Best}^{R} represents the individual that produces the optimal temperature solution in the Rth generation, and F is the influencing factor with a value range is between 0-1, indicating the weight of the optimal individual in the mutation process;

step 5.5: finding the symmetric solutions for the number of px·npop individuals at the back after non-dominated sorting, and group all the symmetric solutions produced by this process into a population pop3;

step 5.6: combining pop0 pop1 pop2 pop3 to form a temporary population, sort all individuals in the temporary population species non-dominantly, select the first npop individuals to form a new generation population pop0 according to the elite retention strategy, and eliminate all other individuals;

step 5.7: repeating steps 3 to 6 until the maximum number of iterations of 1000 is completed, at this time, the individual at the top is the final temperature solution.

These and other objectives, features, and advantages of the present invention will become apparent from the following detailed description, the accompanying drawings, and the appended claims.

### BRIEF DESCRIPTION OF THE DRAWINGS

FIG. 1 shows the spectral radiation curves corresponding to different emissivity models.

FIG. 2 is a flow chart of emissivity classification based on BP network model.

FIG. 3 is a diagram of the positional relationship between the symmetric solution and the optimal solution of individuals with poor fitness.

FIG. 4 is a flowchart of multi-spectral calculation and solution based on the INS GA-II algorithm.

FIG. 5 is a structural diagram of a multi-spectral temperature measuring device based on an adaptive emissivity model.

FIG. 6 shows the trend of seven emissivity models.

FIG. 7 is a BP network structure diagram.

FIG. 8 shows the temperature measurement results based on the adaptive emissivity model under high temperature background.

### DETAILED DESCRIPTION OF THE PREFERRED EMBODIMENT

The present invention will be described in detail below in conjunction with specific embodiments.

### Embodiment 1

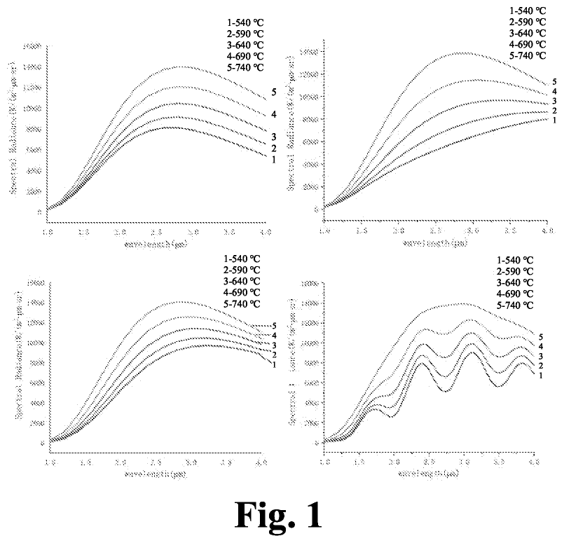

According to FIGS. 1 to 8, the present invention provides a multi-spectral temperature measuring device and a temperature measuring method based on an adaptive emissivity model, which are specifically:

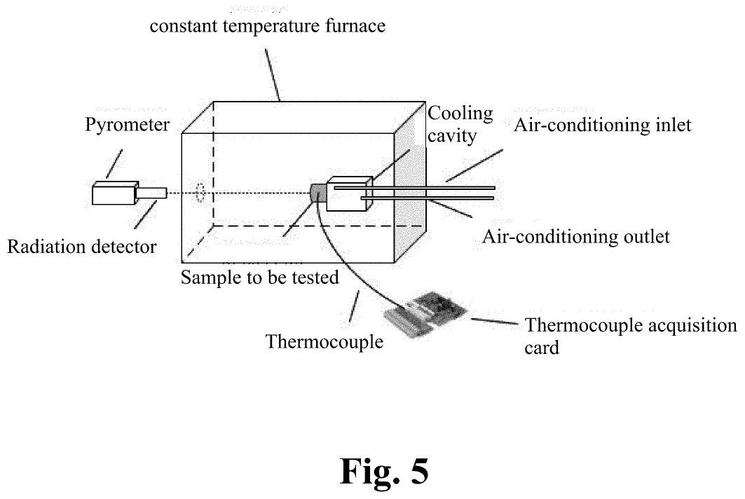

As shown in FIG. 5, the present invention provides a multi-spectral temperature measurement device based on an adaptive emissivity model. The device includes a pyrometer, a radiation detector, a constant temperature furnace, a cooling chamber, a cold air inlet pipe, a cold air outlet pipe, and a thermoelectric Couple and thermocouple acquisition card;

The pyrometer is connected to a radiation detector, and the constant-temperature furnace has a small hole larger than the radiation detector. The radiation detector measures the optical radiation data of the sample to be tested through the small hole. The sample to be tested is placed in the cooling chamber, so a cold air inlet pipe and a cold air outlet pipe are arranged in the cooling cavity, the sample to be tested is connected to a thermocouple, and the thermocouple is connected to a thermocouple acquisition card.

The thermocouple adopts a K-type thermocouple, and the thermocouple acquisition card adopts a 16-channel thermocouple acquisition card.

A multi-spectral temperature measurement method based on an adaptive emissivity model, comprises steps as follows.

Step 1: collect the spectral radiation data of the sample to be tested in a certain wavelength range through a pyrometer;

wherein the step 1 specifically comprises:

collecting spectral radiation data of the sample to be tested in the wavelength range of 1.7-2.2 microns by a pyrometer; wherein collection process is divided into a stable phase, two cooling processes and two heating processes; first, the temperature of the temperature control room is adjusted to 690° C. to maintain It takes about 30 s to reach the stable stage; then the cold air is introduced from the cold air inlet pipe to the cooling chamber to reduce the surface temperature of the sample to be tested; after maintaining for about 150 s, the cold air is stopped to reach the first cooling stage;

After that, the temperature of the sample gradually recovered. After the recovery process lasted for 489 s, the temperature of the sample recovered to 681.5° C., reaching the first heating stage;

Pass the cold air into the cooling chamber again from the cold air inlet pipe to reduce the surface temperature of the sample to be tested. After maintaining for about 150 seconds, stop passing the cold air to the second cooling stage;

The temperature of the sample gradually recovered. After the recovery process lasted 489 s, the temperature of the sample recovered to 681.5° C., reaching the second heating stage, completing the collection of the spectral radiation data of the sample to be tested.

Step 2: Train the BP network and select the emissivity model based on the spectral radiation data of the sample to be tested;

There are several common emissivity models as follows. The four emissivity models include exponential model, sine model, linear model and quadratic model as shown by equations (1)-(4).

ln ε(λ,T)=a+bλ (1)

ε(λ,T)=aλ²+bλ+c (2)

ε(λ,T)=a₀+a₁λ (3)

ε(λ,T)=a+b sin(cλ+d) (4)

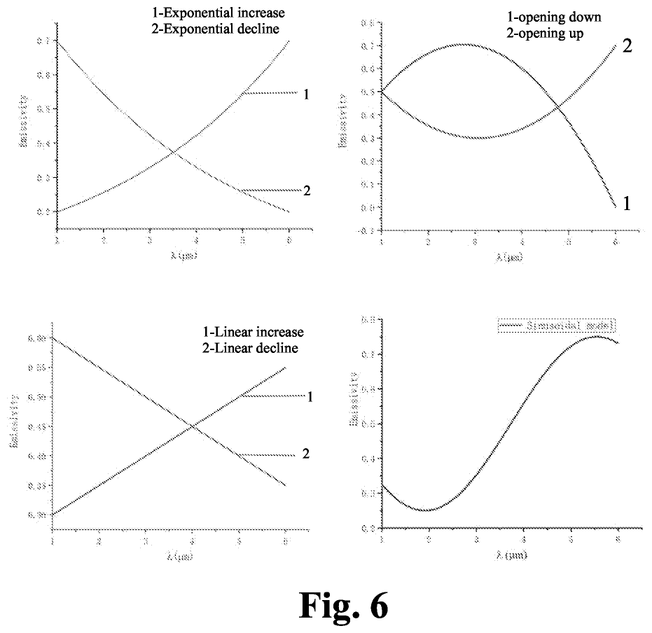

First, according to these equations, the emissivity data of various shapes are generated and classified through theoretical simulation, which can be covered by the seven trends shown in FIG. 6.

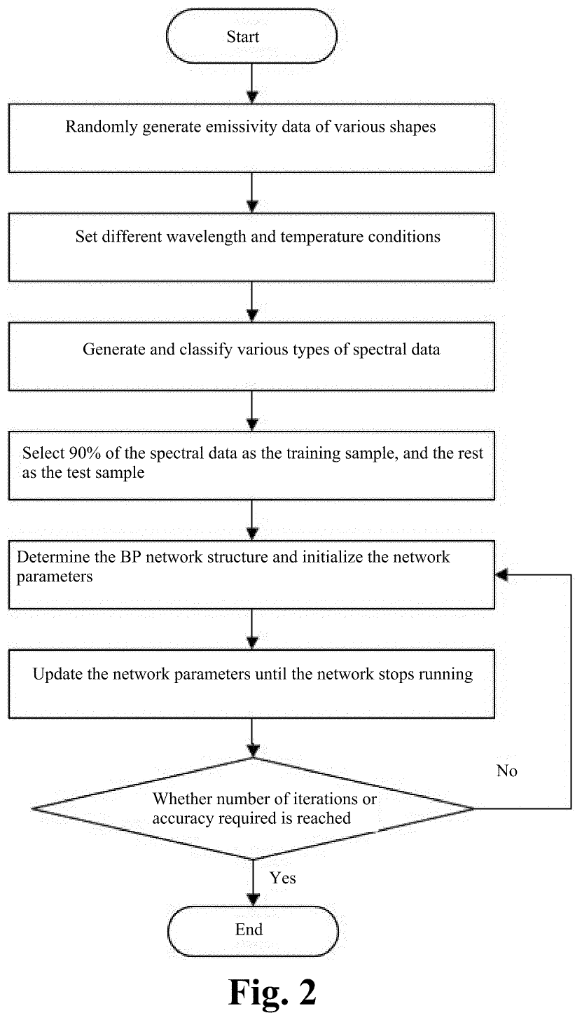

As shown in FIG. 2, the step 2 is specifically:

Step 2.1: According to the four emissivity models, within the range of 1.7-2.2 microns, take one point every 0.1 microns, a total of 6 wavelength points, select the emissivity range of 0.3-1, within the emissivity range and six wavelengths Under the conditions of, seven different emissivity data are generated, each with 74 groups, a total of 518 emissivity samples, and in each emissivity sample, 70 groups are taken as the training set emissivity source data, and the remaining 4 sets of emissivity source data as test set;

Take seven 0-1 combinations as classification labels, 1-0-0-0-0-0-0 as the first emissivity label, and 0-1-0-0-0-0-0 as the second One emissivity tag, 0-0-1-0-0-0-0 as the third emissivity tag, 0-0-0-1-0-0-0 as the fourth emissivity tag, 0-0-0-0-1-0-0 as the fifth emissivity label, 0-0-0-0-0-1-0 as the sixth emissivity label, 0-0-0-0-0-0-1 as the seventh emissivity tag;

Step 2.3: Set the temperature conditions. Set the ambient temperature to 690° C. Take one point every 10° C. within the range of 575-685° C. for the blackbody temperature. There are 12 temperature points in total. The generated 518 sets of emissivity samples are used in 12 Spectral radiation data is generated under temperature conditions, a total of 6216 sets of samples, of which, the spectral radiation data generated from the training set emissivity source data is used as the training sample, a total of 5880 sets, accounting for 94.6% of the total sample, the test set emissivity The spectrum data generated by the source data is used as the test sample, a total of 336 groups, accounting for 5.4% of the total sample;

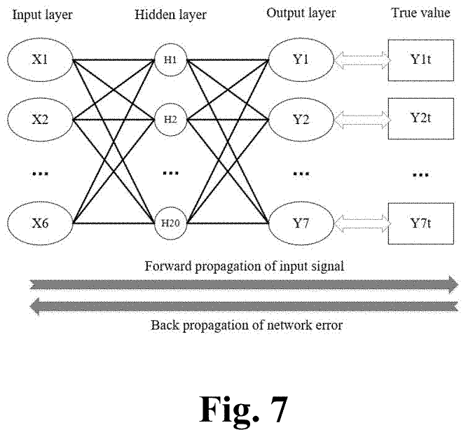

Step 2.4: Using a typical three-layer BP network structure, the number of hidden layers is 1 layer, where the number of neurons in the input layer corresponds to the number of wavelengths, which is 6, the number of neurons in the hidden layer is 20, and the number of neurons in the output layer Neurons are used to display the classification results. According to the seven 0-1 combinations, the number of neurons should be set to 7, and the final network structure is 6-20-7. As shown in FIG. 7, for the BP neural network after running As a result, it should be converted into seven 0-1 combinations, and the maximum value of the seven neurons should be set to 1, and the rest should be set to zero to correspond to the classification label;

Step 2.5: Initialize the network parameters, normalize the spectrum data and transmit it to the BP network. According to the rules of the gradient descent method, the input data is propagated forward and the error is propagated back. The network parameters are constantly updated, and two abort rules are set for iteration., Complete BP network training;

The two termination rules are specifically: one of the rules is: the maximum number of iterations is set to 10000; the other is: when the data has not changed for 40 consecutive times, it is not necessary to wait until the maximum number of iterations, and directly terminate.

Corresponding one-to-one between the type of spectral data and the type of emissivity shape, the spectral data is generated under different blackbody temperatures and ambient temperatures through the following formula:

M_{λ,T}_{ₘ}=ε_{λ}M_{λ,T}_{_{b}}+(1−ε_{λ})M_{λ,T}_{ᵣ}

wherein M_{λ,T}_{ₘ} is the total radiation output received by the detector, M_{λ,T}_{_{b}} is the black body radiation output of the measurement target, M_{λ,T}_{ᵣ} is the amount of radiation reaching the surface of the object under test in the surrounding high temperature environment, ε_{λ} is the emissivity of the surface of the object under test, T_{b} is the surface of the object under test the blackbody temperature, Tₘ is the measurement temperature of the radiation pyrometer, and Tᵣ is the ambient temperature;

The difference between the generated spectral shapes is used as the basis for neural network recognition.

Step 3: Input the spectral radiation data of the sample to be tested into the trained BP network, and select the emissivity model;

If there is only one black body temperature point to be measured, then the emissivity model recognized by the neural network shall prevail; if there is more than one black body temperature point to be measured, the spectral data at all temperature points are input to the neural network and selected The emissivity model with the highest total number of identifications is used as the emissivity model of the object. Specifically: if the temperature of the surface of the object is constant, that is, there is only one temperature point to be measured, then the emissivity model type output by the neural network is the emissivity model suitable for temperature measurement. If the temperature of the surface of the object changes, that is, there are multiple temperature points that need to be measured, then the emissivity model with the most judgment results of all temperature points by the neural network is the main one.

The step 3 is specifically:

Select six wavelengths, respectively 1.7, 1.8, 1.9, 2.0, 2.1, 2.2 microns, and input the acquired spectrum data into the trained BP network according to the same normalization method as the training data; and according to the principle, take the maximum value the judgment rule of the network output result as 1 and the remaining values as 0, respectively corresponding to seven classification labels to indicate the classification of the spectrum data by the network;

The emissivity model with the highest recognition rate of the number of temperature points is selected as the emissivity model. After BP network recognition, the sine model has the highest recognition rate, and the sine model is selected.

Step 4: According to the selected emissivity model, transform the emissivity model into a single objective constrained optimization equation to obtain the objective equation;

The step 4 is specifically as follows.

According to the selected emissivity model, the emissivity model is converted into a single-objective constraint optimization equation. For a multi-wavelength pyrometer with n channels, after selecting the emissivity model, a set of emissivity values equal to the number of channels is obtained, determine the implicit function equation group between the emissivity coefficient and the target true temperature, and express the implicit function equation group between the emissivity coefficient and the target true temperature by the following formula:

$$\{ \begin{matrix}{M}_{{λ}_{1} , {T}_{b}} = \frac{{M}_{{λ}_{1} , {T}_{m}} - ( 1 - {ɛ}_{1} ) {M}_{{λ}_{1} , {T}_{r}}}{{ɛ}_{1}} \\ {M}_{{λ}_{2} , {T}_{b}} = \frac{{M}_{{λ}_{2} , {T}_{m}} - ( 1 - {ɛ}_{2} ) {M}_{{λ}_{2} , {T}_{r}}}{{ɛ}_{2}} \\ … \\ {M}_{{λ}_{n} , {T}_{b}} = \frac{{M}_{{λ}_{n} , {T}_{m}} - ( 1 - {ɛ}_{n} ) {M}_{{λ}_{n} , {T}_{r}}}{{ɛ}_{n}}\end{matrix}$$

Wherein λₙ is the wavelength of an nth channel, εₙ is the emissivity of the nth channel at the wavelength λₙ, M_{λ}_{ₙ}_{,T}_{_{b}} is the wavelength λₙ, and the blackbody temperature T_{b} is the ideal blackbody radiation emission degree, M_{λ}_{ₙ}_{,T}_{ᵣ} is ambient radiation exitance under a condition with a the wavelength λₙ and a ambient temperature, M_{λ}_{ₙ}_{,T}_{ₘ} is the degree of emission of radiation received by the pyrometer;

Convert the implicit function equations between the emissivity coefficient and the target true temperature into an optimized equation for solving the emissivity and the true temperature, and get the target equation through the following formula Δ:

$$\{ \begin{matrix}Δ = min {\sum }_{i = 1}^{n} [ {M}_{{λ}_{i} , {T}_{m}} - ( 1 - {ɛ}_{{λ}_{i}} ) {M}_{{λ}_{i} , {T}_{r}} - {ɛ}_{{λ}_{i}} {M}_{{λ}_{i} , T} ] \\ {ɛ}_{{λ}_{i}} = f ( λ , T ) \\ 0 \leq {ɛ}_{{λ}_{i}} \leq 1\end{matrix}$$

Wherein ε_{λ}_{ᵢ} is the emissivity calculated by the emissivity model at the i-th channel wavelength, with a value ranging from 0 to 1, and T is the true surface temperature of the object to be measured.

Step 5: According to the target equation, the temperature of the sample to be tested is solved.

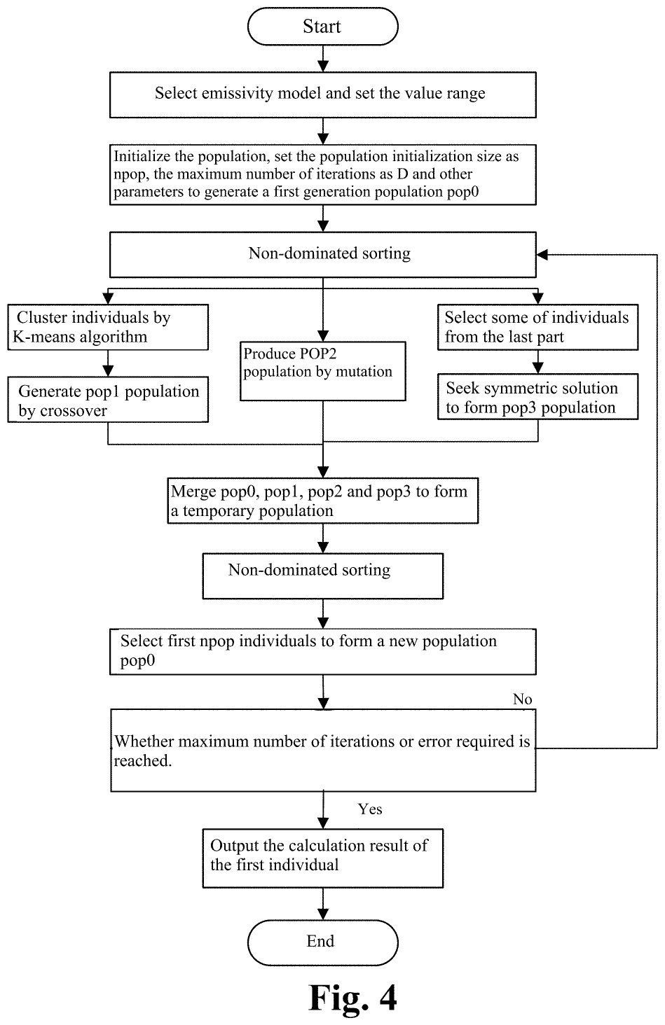

According to FIG. 4, the step 5 specifically comprises steps of:

step 5.1: initializing the population parameters, and set the feasible range of the emissivity model parameters according to the selected emissivity model, the number of population individuals npop the crossover rate pc, the mutation rate pm, the number of clusters k, the proportion of individuals for symmetric solution px, and the parameters of the maximum number of iterations D;

step 5.2: generating an initial population within the range of feasible solution parameters of the emissivity model, and perform a non-dominated sorting on all individuals in the order of fitness from good to poor according to the target equation;

step 5.3: dividing the population into k clusters according to the Euclidean distance between individuals according to the K-means algorithm, randomly select two clusters, first randomly selecting two individuals in each cluster to perform the binary tournament algorithm, and then performing the crossover operation for pc·npop times, the new individuals pop1 is generated by the cross to form a population;

step 5.4: determining the rules of mutation, randomly selecting pm·npop individuals to perform mutation operations, and the new individuals generated by mutation form a pop2 population, wherein the mutation rules are expressed by the following formula X^{R+1}:

X^{R+1}=X^{R}+F·(X_{Best}^{R}−Xᵢ^{R})

wherein R represents the Rth generation, X represents an individual in the population, Xᵢ^{R} represents any random individual in the Rth generation that is different from X, X_{Best}^{R} represents the individual that produces the optimal temperature solution in the Rth generation, and F is the influencing factor with a value range is between 0-1, indicating the weight of the optimal individual in the mutation process;

step 5.5: finding the symmetric solutions for the number of px·npop individuals at the back after non-dominated sorting, and group all the symmetric solutions produced by this process into a population pop3;

step 5.6: combining pop0 pop1 pop2 pop3 to form a temporary population, sort all individuals in the temporary population species non-dominantly, select the first npop individuals to form a new generation population pop0 according to the elite retention strategy, and eliminate all other individuals;

step 5.7: repeating steps 3 to 6 until the maximum number of iterations of 1000 is completed, at this time, the first individual is the final temperature solution.

### Embodiment 2

1. Improvement of the Way of Selecting Individuals for Crossover Operation

For the multi-spectral radiation temperature measurement constrained optimization equation, the NSGA-II algorithm will randomly generate a certain number of individuals within the feasible region of the emissivity model parameters, and each individual represents a temperature solution. Crossover is an important operation to produce new individuals and determines the evolution direction of the population. The traditional NSGA-II algorithm randomly selects two individuals from the population through a binary tournament for comparison, and then selects the individual with a higher level of dominance to participate in the crossover operation. However, this selection method may lead to the selection of two very similar individuals, resulting in the temperature solutions of the representatives of the two parents being similar to the temperature solutions obtained by their children, which is not conducive to the evolution of the population. In order to solve this problem, the K-means algorithm is introduced. First, according to the Euclidean distance between individuals, all individuals in the population are divided into several clusters. The individuals in the same cluster are similar to each other, and the individuals in different clusters are quite different. Before the crossover operation, two clusters are randomly selected, and two individuals in each cluster are selected for the tournament, and the better individual in each cluster is selected as the parents of the crossover operation. The temperature solution obtained in this way must be Will not repeat the temperature solution represented by the parents, thereby increasing the diversity of the population.

2. Improvements to the Mutation Operator

The traditional NSGA-II algorithm uses polynomial mutation or uniform mutation to complete the mutation operation. This mutation is too random and may cause the temperature value obtained by the mutated individual to be worse, which is not conducive to the improvement of population quality. In order to avoid this phenomenon, it is necessary to control the direction of the variation to make it change in the direction conducive to the production of better temperature solutions. This paper adopts the method of introducing the difference equation, and makes the mutated individual approach the direction of the optimal temperature solution in the current population. This method is shown by the following equation.

X^{R+1}=X^{R}+F·(X_{Best}^{R}−Xᵢ^{R});

wherein R represents the Rth generation, X represents an individual in the population, and Xᵢ^{R} represents any random individual different from X in the Rth generation, X_{Best}^{R} represents the individual that produces the optimal temperature solution in the Rth generation, F is the influence factor, with a value range of 0-1, which represents the weight of the optimal individual in the mutation process.

3. Find the Centrosymmetric Solution of Individuals with Poor Fitness

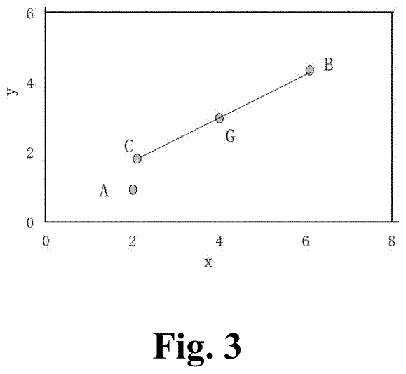

In order to reduce the possibility of falling into a local optimal solution, the search range must be increased on the basis of the original population. This paper uses the solution of the symmetric position of the poor individual. As shown in FIG. 3, A represents the optimal solution of a binary objective equation, B represents an individual with poor fitness, C is the central symmetric solution of B in the value interval, and O is the center of symmetry. In the NSGA-II algorithm, because individual B is far away from the optimal solution A, and its fitness is much smaller than that of the optimal solution A, it has a higher probability of being ranked behind by the non-dominated sorting mechanism, and will be eliminated in the end, but The symmetric solution C is located near the optimal solution. According to this principle, for a part of the individuals ranked last, using their positional relationship with the symmetric solution to find the symmetric solution can increase the diversity of the population and increase the probability of searching for the global optimal solution.

### Embodiment 3

1. Analysis of Simulation Results

After the program iteration is completed, the recognition results of the training set spectral data are shown in Table 1. Among them, the average recognition rate of the training set is 89.2%, the emissivity model with the highest recognition rate is the linear model (up), the recognition rate is 98.9%, and the second is the quadratic model (opening downward), the recognition rate is 96%. The two worst-recognized models in the training set are the exponential model (ascending) and the sine model, with recognition rates of only 78.9% and 79.8%. The results of the test samples are shown in Table 2. The average recognition rate is 81.8%. The exponential model (down), linear model (up), and quadratic model (open downward) have the highest recognition rate, which is 100%. The worst recognition rate is the exponential model (up) and the sine model, the recognition rate is only 56.2% and 50%.

TABLE 1
Recognition results of spectral data samples in the training set

| | | Number of | |
|---|---|---|---|
| Type of | Number of | correct | |
| emissivity | spectral | identification | Correct |
| model | data sets | sets | rate |
| Index model | 840 | 728 | 86.7% |
| (down) | | | |
| Index model | 840 | 663 | 78.9% |
| (up) | | | |
| Sine model | 840 | 670 | 79.8% |
| Linear model | 840 | 767 | 91.3% |
| (down) | | | |
| Linear model | 840 | 831 | 98.9% |
| (up) | | | |
| Secondary | 840 | 806 | 96.0% |
| model (open | | | |
| side down) | | | |
| Secondary | 840 | 781 | 93.0% |
| model (open | | | |
| side up) | | | |
| Total | 5880 | 5246 | 89.2% |

TABLE 2
Recognition results of spectral data samples in the training set

| | | Number of | |
|---|---|---|---|
| Type of | Number of | correct | |
| emissivity | spectral | identification | Correct |
| model | data sets | sets | rate |
| Index model | 48 | 48 | 100% |
| (down) | | | |
| Index model | 48 | 27 | 56.2% |
| (up) | | | |
| Sine model | 48 | 24 | 50% |
| Linear model | 48 | 46 | 95.8% |
| (down) | | | |
| Linear model | 48 | 48 | 100% |
| (up) | | | |
| Secondary | 48 | 48 | 100% |
| model (open | | | |
| side down) | | | |
| Secondary | 48 | 34 | 70.8% |
| model (open | | | |
| side up) | | | |
| Total | 336 | 275 | 81.8% |

Since the values of emissivity generated by various emissivity model equations are completely random, it is possible to generate data with larger shape amplitude or data with smaller shape amplitude. Similar trends may also occur between the two models. If the generated emissivity value is just in the part where the shape of the two emissivity models is similar, then the shape of the spectral data generated by the two models under the same conditions will be different, leading to bias in the judgment of the neural network.

Due to the large wavelength range of the spectrum data measured through experiments, the appropriate wavelength should be selected according to the number of channels of the multi-spectral pyrometer. Again, choose six wavelengths, 1.7, 1.8, 1.9, 2.0, 2.1, 2.2 microns, respectively, and input the spectral data obtained from the experiment into the trained neural network in the same normalized manner as the training data. The judgment rule of the network output result is consistent with the simulation process. According to the principle of taking the maximum value as 1 and the remaining values as 0, there are seven classification labels respectively corresponding to the classification of the spectrum data by the network.

In this experiment, two heating and two cooling processes were carried out, resulting in a total of 598 temperature points. There are many temperature points, so the emissivity model with the highest recognition rate of temperature points should be selected as the emissivity model used in this experiment. After the identification of the network, the identification results are shown in Table 3. It can be seen that the sine model has the highest degree of recognition. This shows that for this experiment, the sine model is theoretically the most realistic emissivity model for the object, so the sine model should be used for the subsequent calculation of the temperature.

TABLE 3
The results of the experimentally measured spectral data at 598
temperature points after being identified by the neural network

| | Number of | |
|---|---|---|
| Emissivity | spectral | Proportion |
| model | data sets | of model |
| Index model | 0 | 0% |
| (down) | | |
| Index model | 60 | 10.03% |
| (up) | | |
| Sine model | 530 | 88.63% |
| Linear model | 6 | 1% |
| (down) | | |
| Linear model | 0 | 0% |
| (up) | | |
| Secondary | 2 | 0.33% |
| model (open | | |
| side down) | | |
| Secondary | 0 | 0% |
| model (open | | |
| side up) | | |
| Total | 598 | 100% |

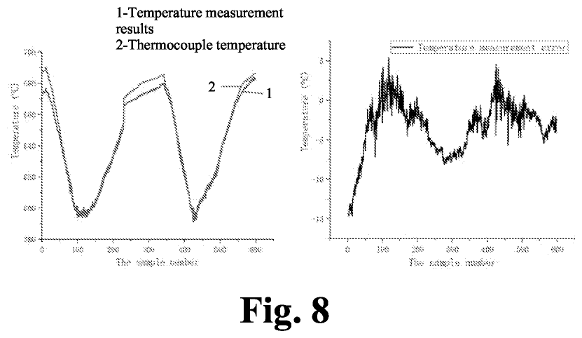

According to the self-adaptive recognition result of the neural network, the sine model is selected as the emissivity model, and the temperature measurement curve shown in FIG. 8 is provided as the temperature measurement result obtained by the temperature measurement method proposed by the present invention. Except for the initial stable stage, the entire measurement the maximum temperature measurement error of the temperature process is within 8K. It can be seen that the volatility in the whole temperature measurement process is small, the calculated temperature range difference between adjacent temperatures is small, and the temperature measurement is very accurate.

The above is only a preferred embodiment of a multi-spectral temperature measurement device and its temperature measurement method based on an adaptive emissivity model, and protection of a multi-spectral temperature measurement device and its temperature measurement method based on an adaptive emissivity model The scope is not limited to the above-mentioned embodiments, and all technical solutions under this idea belong to the protection scope of the present invention. It should be pointed out that for those skilled in the art, several improvements and changes made without departing from the principle of the present invention should also be regarded as the protection scope of the present invention.

What is claimed is:

1. A multi-spectral temperature measuring device based on an adaptive emissivity model, comprising: a pyrometer, a radiation detector, a constant temperature furnace, a cooling chamber, a cold air inlet pipe, a cold air outlet pipe, a thermocouple and a thermocouple collection card;
wherein the pyrometer is connected to a radiation detector, and the constant-temperature furnace has a small hole larger than the radiation detector. The radiation detector measures the optical radiation data of the sample to be tested through the small hole. The sample to be tested is placed in the cooling chamber, so A cold air inlet pipe and a cold air outlet pipe are arranged in the cooling cavity, the sample to be tested is connected to a thermocouple, and the thermocouple is connected to a thermocouple acquisition card.

2. A multi-spectral temperature measuring device based on an adaptive emissivity model, which is characterized in that the thermocouple adopts a K-type thermocouple, and the thermocouple acquisition card adopts a 16-channel thermocouple acquisition card.

3. A multi-spectral temperature measurement method based on an adaptive emissivity model, which is based on a multi-spectral temperature measurement device based on an adaptive emissivity model as claimed in claim 1, comprises the following steps of:
Step (1): collecting the spectral radiation data of the sample to be tested within a certain wavelength range through a pyrometer;
Step (2): training the BP network and select the emissivity model based on the spectral radiation data of the sample to be tested;
Step (3): inputting the spectral radiation data of the sample to be tested into the trained BP network, and select the emissivity model;
Step (4): according to the selected emissivity model, transforming the emissivity model into a single objective constrained optimization equation to obtain the objective equation; and
Step (5): according to the target equation, the temperature of the sample to be tested is solved.

4. The multi-spectral temperature measurement method based on an adaptive emissivity model according to claim 3, wherein the step (1) specifically comprising:
collecting the spectral radiation data of the sample to be tested in the wavelength range of 1.7-2.2 microns by a pyrometer; wherein the collection process is divided into a stable phase, two cooling processes and two heating processes; first, the temperature of the temperature control room is adjusted to 690° C. to maintain, it takes about 30 s to reach the stable stage; then the cold air is introduced from the cold air inlet pipe to the cooling chamber to reduce the surface temperature of the sample to be tested.
after maintaining it for about 150 s, the cold air is stopped to reach the first cooling stage; after that, the temperature of the sample gradually recovered; after the recovery process lasted 489 s, the temperature of the sample recovered to 681.5° C., reaching the first heating stage; Pass the cold air into the cooling chamber again from the cold air inlet pipe to reduce the surface temperature of the sample to be tested; after maintaining for about 150 seconds, stop passing the cold air to the second cooling stage; the temperature of the sample gradually recovered; after the recovery process lasted 489 s, the temperature of the sample recovered to 681.5° C., reaching the second heating stage, completing the collection of the spectral radiation data of the sample to be tested.

5. The multi-spectral temperature measurement method based on an adaptive emissivity model according to claim 3, wherein the step (2) specifically comprises:
step (2.1): according to the four emissivity models, within the range of 1.7-2.2 microns, take one point every 0.1 microns, a total of 6 wavelength points, select the emissivity range of 0.3-1, within the emissivity range and six wavelengths under the conditions of, seven different emissivity data are generated, each with 74 groups, a total of 518 emissivity samples, and in each emissivity sample, 70 groups are taken as the training set emissivity source data, and the remaining 4 sets of emissivity source data as test set;
step (2.2): taking seven 0-1 combinations as classification labels, 1-0-0-0-0-0-0 as the first emissivity label, and 0-1-0-0-0-0-0 as the second One emissivity tag, 0-0-1-0-0-0-0 as the third emissivity tag, 0-0-0-1-0-0-0 as the fourth emissivity tag, 0-0-0-0-1-0-0 as the fifth emissivity label, 0-0-0-0-0-1-0 as the sixth emissivity label, 0-0-0-0-0-0-1 as the seventh emissivity tag;
step (2.3): setting the temperature conditions. Set the ambient temperature to 690° C. Take one point every 10° C. within the range of 575-685° C. for the blackbody temperature. There are 12 temperature points in total. The generated 518 sets of emissivity samples are used in 12 spectral radiation data is generated under temperature conditions, a total of 6216 sets of samples, of which, the spectral radiation data generated from the training set emissivity source data is used as the training sample, a total of 5880 sets, accounting for 94.6% of the total sample, the test set emissivity the spectrum data generated by the source data is used as the test sample, a total of 336 groups, accounting for 5.4% of the total sample;
step (2.4): using a typical three-layer BP network structure, the number of hidden layers is 1 layer, where the number of neurons in the input layer corresponds to the number of wavelengths, which is 6, the number of neurons in the hidden layer is 20, and the number of neurons in the output layer Neurons are used to display the classification results. According to the seven 0-1 combinations, the number of neurons should be set to 7, and the final network structure should be 6-20-7. For the results of the BP neural network, it should be converted to seven according to 0-1 combination, and set the maximum value of the seven neurons to 1, and set the rest to zero to correspond to the classification label;
step (2.5): initializing the network parameters, normalize the spectrum data and transmit it to the BP network. According to the rules of the gradient descent method, the input data is propagated forward and the error is propagated back. The network parameters are constantly updated, and two abort rules are set for iteration, completing BP network training; the two termination rules are specifically;
wherein one of the rules is: the maximum number of iterations is set to 10000; the other is: when the data has not changed for 40 consecutive times, it is not necessary to wait until the maximum number of iterations, and directly terminate.

6. The multi-spectral temperature measurement method based on an adaptive emissivity model according to claim 5, wherein the four emissivity models comprises an exponential model, a sine model, a linear model and a quadratic model.

7. The multi-spectral temperature measurement method based on an adaptive emissivity model according to claim 3, wherein the type of spectral data is one-to-one corresponding to the type of emissivity shape, and the following formulas are used for different blackbody temperatures and Generate spectral data at ambient temperature:
M_{λ,T}_{ₘ}=ε_{λ}M_{λ,T}_{_{b}}+(1−ε_{λ})M_{λ,T}_{ᵣ};
wherein M_{λ,T}_{ₘ} is the total radiation output received by the detector, M_{λ,T}_{_{b}} is the blackbody radiation output of the measurement target, M_{λ,T}_{ᵣ} is the amount of radiation reaching the surface of the object under test in the surrounding high temperature environment, ε_{λ} is the emissivity of the surface of the object under test, T_{b} is the surface of the object under test on the blackbody temperature is the measurement temperature of the radiation pyrometer, and is the ambient temperature; The difference between the generated spectral shapes is used as the basis for neural network recognition.

8. The multi-spectral temperature measurement method based on an adaptive emissivity model according to claim 3, wherein the step (3) is specifically:
selecting six wavelengths, respectively 1.7, 1.8, 1.9, 2.0, 2.1, 2.2 microns, and input the acquired spectrum data into the trained BP network according to the same normalization method as the training data. The judgment rule of the network output result according to the principle of taking the maximum value as 1 and the remaining values as 0, each corresponds to seven classification labels to indicate the classification of spectral data by the network;
selecting the emissivity model with the highest recognition rate of the number of temperature points as the emissivity model; after the recognition of the BP network, the sine model has the highest recognition rate, and the sine model is selected.

9. The multi-spectral temperature measurement method based on an adaptive emissivity model according to claim 3, wherein the step (4) specifically comprises:
according to the selected emissivity model, transforming the emissivity model into a single-objective constraint optimization equation. For a multi-wavelength pyrometer with n channels, after selecting the emissivity model, a set of emissivity values equal to the number of channels is obtained, determine the implicit function equation group between the emissivity coefficient and the target true temperature, and express the implicit function equation group between the emissivity coefficient and the target true temperature by the following formula:
$$\{ \begin{matrix}{M}_{{λ}_{1} , {T}_{b}} = \frac{{M}_{{λ}_{1} , {T}_{m}} - ( 1 - {ɛ}_{1} ) {M}_{{λ}_{1} , {T}_{r}}}{{ɛ}_{1}} \\ {M}_{{λ}_{2} , {T}_{b}} = \frac{{M}_{{λ}_{2} , {T}_{m}} - ( 1 - {ɛ}_{2} ) {M}_{{λ}_{2} , {T}_{r}}}{{ɛ}_{2}} \\ … \\ {M}_{{λ}_{n} , {T}_{b}} = \frac{{M}_{{λ}_{n} , {T}_{m}} - ( 1 - {ɛ}_{n} ) {M}_{{λ}_{n} , {T}_{r}}}{{ɛ}_{n}}\end{matrix}$$
wherein λₙ is the wavelength of an nth channel, εₙ is the emissivity of an nth channel at a wavelength λₙ, M_{λ}_{ₙ}_{,T}_{_{b}} is a wavelength λₙ, and the blackbody temperature T_{b} is the ideal blackbody radiation emission degree, M_{λ}_{ₙ}_{,T}_{ᵣ} is the wavelength λₙ, and the ambient temperature Tᵣ is the ambient radiation under the condition, M_{λ}_{ₙ}_{,T}_{ₘ} is the degree of emission of radiation received by the pyrometer;
converting the implicit function equations between the emissivity coefficient and the target true temperature into an optimized equation for solving the emissivity and the true temperature, and get the target equation through the following formula Δ:
$$\{ \begin{matrix}Δ = min {\sum }_{i = 1}^{n} [ {M}_{{λ}_{i} , {T}_{m}} - ( 1 - {ɛ}_{{λ}_{i}} ) {M}_{{λ}_{i} , {T}_{r}} - {ɛ}_{{λ}_{i}} {M}_{{λ}_{i} , T} ] \\ {ɛ}_{{λ}_{i}} = f ( λ , T ) \\ 0 \leq {ɛ}_{{λ}_{i}} \leq 1\end{matrix}$$
wherein, ελᵢ is the emissivity calculated by the emissivity model at the i-th channel wavelength, with a value ranging from 0 to 1, and T is the true surface temperature of the object to be measured.

10. The multi-spectral temperature measurement method based on an adaptive emissivity model according to claim 3, wherein the step (5) specifically comprises:
step (5.1): initializing the population parameters, and set the feasible range of the emissivity model parameters according to the selected emissivity model, the number of population individuals npop the crossover rate pc, the mutation rate pm, the number of clusters k, the proportion of individuals for symmetric solution px, and the parameters of the maximum number of iterations D;
step (5.2): generating an initial population within the range of feasible solution parameters of the emissivity model, and perform a non-dominated sorting on all individuals in the order of fitness from good to poor according to the target equation;
step (5.3): dividing the population into k clusters according to the Euclidean distance between individuals according to the K-means algorithm, randomly select two clusters, first randomly selecting two individuals in each cluster to perform the binary tournament algorithm, and then performing the crossover operation for pc·npop times, the new individuals pop1 is generated by the cross to form a population;
step (5.4): determining the rules of mutation, randomly selecting pm·npop individuals to perform mutation operations, and the new individuals generated by mutation form a pop2 population, wherein the mutation rules are expressed by the following formula X^{R+1}:
X^{R+1}=X^{R}+F·(X_{Best}^{R}−Xᵢ^{R})
wherein R represents the Rth generation, X represents an individual in the population, Xᵢ^{R} represents any random individual in the Rth generation that is different from X, X_{Best}^{R} represents the individual that produces the optimal temperature solution in the Rth generation, and F is the influencing factor with a value range is between 0-1, indicating the weight of the optimal individual in the mutation process;
step (5.5): finding the symmetric solutions for the number of px·npop individuals at the back after non-dominated sorting, and group all the symmetric solutions produced by this process into a population pop3;
step (5.6): combining pop0 pop1 pop2 pop3 to form a temporary population, sort all individuals in the temporary population species non-dominantly, select the first npop individuals to form a new generation population pop0 according to the elite retention strategy, and eliminate all other individuals;
step (5.7): repeating steps (3) to (6) until the maximum number of iterations of 1000 is completed, at this time, the individual at the top is the final temperature solution.
